(19) United States
(12) Patent Application Publication
(10) Pub. No.: US 2010/0110388 A1
(43) Pub. Date: May 6, 2010

(54) LIGHT-SOURCE MODULE AND PROJECTOR HAVING SAME

(75) Inventor: YI-PING HSIEH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/340,748

(22) Filed: Dec. 22, 2008

(30) Foreign Application Priority Data
Oct. 30, 2008 (CN) 200810305294.3

(51) Int. Cl. G03B 21/00; F21V 1/00; F21V 9/00

(52) U.S. Cl. 353/31; 362/235; 362/231

(57) ABSTRACT

A light-source module includes a casing, and a number of light-source units. The casing defines a number of receiving holes on the walls thereof corresponding to the light-source units. Each light-source unit is received in a corresponding receiving hole. Each light-source unit includes a light source, a converging lens disposed on the optical path of the light emitted from the light source, and a spacer spaced the light source and the converging lens.

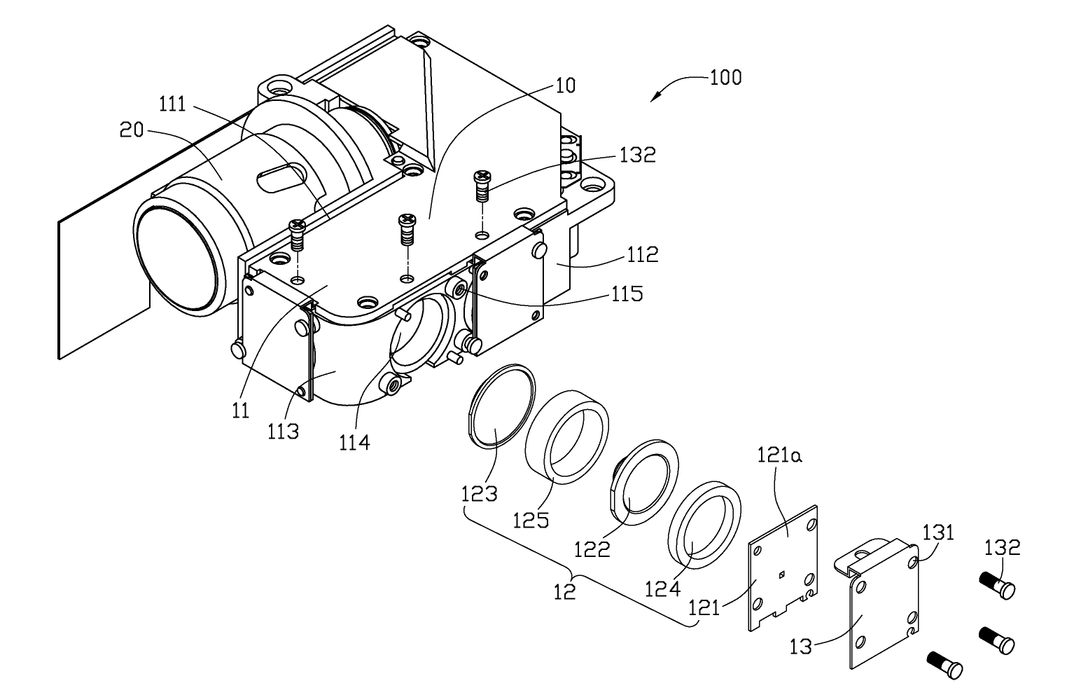

### TECHNICAL FIELD

The present disclosure relates to projectors and, particularly, to a compact light-source module and a projector having the same.

### DESCRIPTION OF THE RELATED ART

Projectors are known to typically include a light-source module having at least one light source, an electro-optical device for forming an optical image according to image information by using light beams emitted from the light sources, a projection lens for enlarging and projecting the optical image formed by the electro-optical device, and an outer casing for housing these components. Such projectors are widely used for multimedia presentations at conferences, academic meetings, exhibitions, and the like.

A typical light-source module for a projector usually has at least one light source, and at least one converging lens corresponding to each light source for converging the light emitted from the corresponding light source. In order to keep a certain distance for the converging lens from the corresponding light source, typically, the converging lens are assembled in the light-source module by securing the converging lens to secure portions, such as frames and so on. As a result, the light-source module is usually bulky and difficult to be assembled.

What is needed, therefore, is a projector with a compact light-source module to overcome the above-described problems.

### BRIEF DESCRIPTION OF THE DRAWING

Many aspects of the present light-source module and projector can be better understood with references to the accompanying drawings. The components in the drawing are not necessarily drawn to scale, the emphasis instead being placed upon clearly illustrating the principles of the present light-source module and projector.

The drawing is a schematic, partially exploded view of a projector according to an exemplary embodiment.

### DETAILED DESCRIPTION OF THE EMBODIMENTS

Embodiments of the present disclosure will now be described in detail below, with reference to the accompanying drawing.

Referring to the drawing, a projector 100 according to an exemplary embodiment is shown. The projector 100 includes a light-source module 10, an electro-optical device (not visible), and a projection lens module 20. In the present embodiment, the electro-optical device is a digital micromirror device (DMD).

The projector 100 can project an image onto a screen (not shown). The formation of the image on a screen may be accomplished by the following process: firstly, light emitted from the light-source module 10 is concentrated and reflected to the DMD by optical components (not shown), such as converging lens and reflecting mirror. The DMD then reflects the light and produces the image towards the projection lens module 20 which focusing the image and then projects the image onto the screen.

The light-source module 10 includes a casing 11, and at least one light-source unit 12. In the present embodiment, the light-source module 10 includes three light-source units 12.

The casing 11 is substantially a cube including a first sidewall 111 adjacent to the projection lens module 20, an opposite second sidewall 112 away from the projection lens module 20, and an end wall 113 connecting the first and second sidewalls 111 and 112. The first sidewall 111 and the second sidewall 112 are substantially parallel to the projection lens module 20. The end wall 113 is substantially perpendicular to the optical axis of the projection lens module 20. The casing 11 defines three receiving holes 114 for receiving the three light-source units 12. Two of the three receiving holes 114 are defined on the second sidewall 112, and the other receiving hole 114 is defined on the end wall 1 13.

The structures of the three light-source units 12 are substantially the same. Each light-source unit 12 includes a light source 121, at least one converging lens, and at least one spacer. In the present embodiment, each light-source unit 12 has two converging lenses including a first lens 122 and a second lens 123, and two spacers including a first spacer 124 and a second spacer 125. The light source 121, the first spacer 124, the first lens 122, the second spacer 125, and the second lens 123 are arranged along the optical path of the light emitted from the light source 121 in sequence. The total length of the light-source unit 12 is substantially equal to the depth of the corresponding receiving hole 114.

In the present embodiment, the three light sources 121 of the three light-source units 12 are a red light emitting diode (LED) light source, a blue LED light source, and a green LED light source, respectively. Each light source includes a driving circuit board 121a and a LED array (not visible) mounted on a surface of the driving circuit board 121a facing the first lens 122. The LED array is substantially located at the center of the driving circuit board 121a.

The outer diameters of the first spacer 124, the first lens 122, the second spacer 125, and the second lens 123 are substantially the same or equal to the diameter of the corresponding receiving hole 114. The first spacer 124 and the second spacer 125 are ring-shaped. The inner diameter of the first spacer 124 is bigger than the diameter of the LED array, so that, the first spacer 124 is in direct contact with the driving circuit board 121a with the LED array surrounded therein. The driving circuit board 121a can be secured to the casing 11 directly to fix the light source 121.

In the present embodiment, the light-source module 10 further includes three support boards 13. Each driving circuit board 121a can be mounted on a support board 13. In the present embodiment, each support board 13 defines a number of through holes 131, and the casing 11 defines a number of screw holes 115 corresponding to the through holes 131. A number of screws 132 are used for securing the support boards 13 to the casing 11.

While assembling the light-source module 10, the second lens 123, the second spacer 125, the first lens 122, the first spacer 124, and the light source 121 can be pressed into the receiving hole 114 in sequence, and then secure the driving circuit board 121a of the light source 121 to the casing 11, thus, the second lens 123, the second spacer 125, the first lens 122, the first spacer 124 will be fixed due to pressure of two adjacent elements. The light-source module 10 can be assembled easily.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. A light-source module comprising:
a casing defining one or more receiving holes on at least one wall thereof;
one or more light-source units corresponding to the one or more receiving holes, each light-source unit being received in a corresponding receiving hole, each light-source unit comprising:
a light source;
one or more converging lenses disposed on the optical path of the light emitted from the light source; and
one or more spacers, the light source and a converging lens of the one or more converging lenses adjacent to the light source being spaced by a spacer of the one or more spacers.

2. The light-source module as claimed in claim 1, wherein the one or more receiving holes comprise three receiving holes and the one or more light-source units comprise three light-source units received in the three receiving holes, respectively.

3. The light-source module as claimed in claim 2, wherein the three light sources of the three light-source units are a red light emitting diode (LED) light source, a blue LED light source, and a green LED light source, respectively.

4. The light-source module as claimed in claim 1, wherein the one or more converging lenses comprise a plurality of converging lenses and the one or more spacers comprise a plurality of spacers; each two adjacent converging lenses of each of the one or more light-source units, are spaced by a spacer of the plurality of spacers.

5. The light-source module as claimed in claim 1, wherein each light source comprises a driving circuit board and a LED array mounted on a surface of the driving circuit board facing the one or more converging lens.

6. The light-source module as claimed in claim 5, wherein the LED array is substantially located at the center of the driving circuit board.

7. The light-source module as claimed in claim 5, wherein the inner diameter of the spacer adjacent to the light source is bigger than the diameter of the LED array.

8. The light-source module as claimed in claim 1, wherein outer diameters of the one or more spacers and the one or more converging lenses are substantially the same.

9. The light-source module as claimed in claim 8, wherein outer diameters of the one or more spacers and the one or more converging lenses are substantially equal to the diameter of the corresponding receiving hole.

10. A projector comprising:
a projection lens module; and
a light-source module, the light-source module comprising:
a casing defining one or more receiving holes on at least one wall thereof;
one or more light-source units corresponding to the one or more receiving holes, each light-source unit being received in a corresponding receiving hole, each light-source unit comprising a light source, one or more converging lenses disposed on the optical path of the light emitted from the light source, and one or more spacers, the light source and a converging lens of the one or more converging lenses adjacent to the light source being spaced by a spacer of the one or more spacers.

11. The projector as claimed in claim 10, wherein the projector comprises a first sidewall adjacent to the projection lens module, an opposite second sidewall away from the projection lens module, and an end wall connecting the first sidewall and second sidewall, the first sidewall and the second sidewall are substantially parallel to the projection lens module, the end wall is substantially perpendicular to the optical axis of the projection lens module.

12. The projector as claimed in claim 11, wherein the casing defines two receiving holes in the second sidewall and one receiving hole in the end wall, the one or more light-source units comprise three light-source units received in the three receiving holes, respectively.

13. The projector as claimed in claim 12, wherein the three light sources of the three light-source units are a red light emitting diode (LED) light source, a blue LED light source, and a green LED light source, respectively.

14. The projector as claimed in claim 10, wherein each light-source unit comprises a plurality of converging lenses and a plurality of spacers, each two adjacent converging lenses are spaced by a spacer.

15. The projector as claimed in claim 10, wherein each light source includes a driving circuit board and a LED array mounted on a surface of the driving circuit board facing the one or more converging lens.

16. The projector as claimed in claim 15, wherein the LED array is substantially located at the center of the driving circuit board.

17. The projector as claimed in claim 15, wherein the inner diameter of the spacer adjacent to the light source is bigger than the diameter of the LED array.

18. The projector as claimed in claim 10, wherein outer diameters of the one or more spacers and the one or more converging lenses are substantially the same.

19. The projector as claimed in claim 18, wherein outer diameters of the one or more spacers and the one or more converging lenses are substantially equal to the diameter of the corresponding receiving hole.
